(19) United States
(12) Patent Application Publication
(10) Pub. No.: US 2025/0201222 A1
(43) Pub. Date: Jun. 19, 2025

(54) MUSICAL INSTRUMENT, METHOD, COMPUTER PROGRAM, COMPUTER-PROGRAM PRODUCT, DATA CARRIER, SYSTEM, AND USE

(71) Applicant: ANAPINA INSTRUMENTS GmbH, Pöcking (DE)

(72) Inventor: Thilo HIMSTEDT, Pöcking (DE)

(21) Appl. No.: 18/847,634

(22) PCT Filed: Mar. 10, 2023
(86) PCT No.: PCT/DE2023/000015

§ 371 Date: Sep. 16, 2024

(30) Foreign Application Priority Data
Mar. 17, 2022 (DE) 10 2022 106 320.8

(51) Int. Cl. G10H 1/44

(52) U.S. Cl. CPC G10H 1/44; G10H 2210/561

(57) ABSTRACT

The invention relates to a musical instrument, characterised in that the instrument is designed such that any tonal spaces can be both expanded and modulated/are both expanded and modulated in use, either on the basis of prime-number tone ratios, even those greater than five, or tempered tone ratios, in real time by means of prime number tone ratios, even those greater than five, or by means of tempered tone ratios.

The invention relates to a musical instrument, a method, a computer program, a computer program product, a data carrier, a system and a use.

To date, it has not been possible to use a musical instrument in pure tuning to expand any chords with higher prime-numbered tone ratios in real time and to modulate these chords freely into the higher prime-numbered ratios.

This task is solved by a musical instrument according to claim 1, a method according to claim 11, a computer program according to claim 12, a computer program product according to claim 13, a data carrier according to claim 14, a system according to claim 15 and a use according to claim 16.

The musical instrument according to the invention is set up in such a way that chord expansion and modulation with prime-numbered tone ratios both smaller and larger than five can be realized/is realized in use in real time, this capability of the musical instrument according to the invention being illustrated, for example and in particular with reference to the following explanations.

In this context, it is advantageous, as proven, that it is an electromechanical musical instrument with a tuning device for dynamic retuning of tuning bodies, so that chord extension and modulation with prime-numbered tone ratios both smaller and greater than five can be realized in real time/is realized in use.

Furthermore, it is advantageous in this context that it is an electronic musical instrument with a tuning device for tuning virtual tuning bodies, so that chord expansion and modulation with prime-number tone ratios both smaller and greater than five can be realized/realized in use.

It is also essential to the invention that the musical instrument according to the invention has an electronic computing unit in which the rules and computing methods listed below are carried out, so that after the calculation and/or assignment to the individual tuning bodies-whether real or virtual-a correspondingly free playing, in particular in pure tuning, is possible.

For practicable playing, it is advantageous if the musical instrument according to the invention has at least one control element via which at least one action related to chord extension and modulation context is activated and/or deactivated.

Furthermore, it is advantageous that the at least one chord extension and modulation context-related action is generated by means of at least one computing unit.

For an electromechanical musical instrument, a dynamically retunable organ is described here by way of example and in particular: This is characterized by the fact that each pipe has a mechanical tuning device. These are positioned by suitable servo drives so that each pipe can be retuned to the calculated pitch. The exact positioning is calculated centrally by a computer unit using special software, depending on the tuning inputs of the musician, and is then dynamically executed by the servo drives. Control units (touch screen, switches, MIDI keyboard, pedals, etc.), servo motors and computing unit are digitally connected.

A dynamically retunable software sampler is described here as an example of an electronic musical instrument: This is characterized by the fact that each sample can be retuned by means of a variable playback speed. The exact playback speed and thus the pitch of each sample is calculated centrally by a computing unit depending on the musician's mood-relevant inputs and then executed by the software (audio engine). Control units (touch screen, switches, MIDI keyboard, pedals, etc.) and computing unit are digitally connected to each other.

In the context of the invention, it is advantageous, as proven, that the at least one action related to the chord extension and modulation context is one of the following group:

a. Basic Structure of the Tonal Space (Tonality)

Switching between a tonal space in which the tone ratios in relation to the reference tone are calculated predominantly as integer multiples on the one hand and predominantly as integer divisors on the other;

b. Limitation of the Tonal Space (Limit)

Selection of an upper or lower limit of the prime-numbered tone ratios present in the tone space;

c. Assignment of the Octave Positions of the Tonal Range (Full Keyboard Tuning)

Switching between an octave-bound and a non-octave-bound replacement of the prime-numbered tone ratios defined by selecting an upper or lower limit with larger or smaller prime-numbered tone ratios corresponding to the octave position;

d. Shifting of the Tonal Space or Tonal Spaces (Modulation)

Modulation of a reference tone and its defined tone space or several reference tones and their defined tone spaces that are in prime or whole-number tone ratios via the selection of a prime or whole-number tone ratio;

e. Interleaving Two or More Tonal Spaces (Transition)

Selection of tone locations that continue to exist after modulation;

f. Distance Between Main Pitch Space and Secondary Pitch Spaces (Distance)

Selection of the distance between at least two reference tones of at least two tone spaces via the selection of a prime or integer tone ratio or correspondingly several prime or integer tone ratios;

g. Continuous Change Between a Tempered or One-Dimensional and a Multi-Dimensional Tone Space (Progression)

Switching between a selection of a tuning from a continuous change between any temperament and a tuning based on tone ratios of three (Pythagorean tuning) to a tuning based on tone ratios greater than three.

Conveniently, it is advantageous if the musical instrument according to the invention has at least one playing unit, in particular if the playing unit has at least one playing element from the group keyboard, pedal.

In this context, it is advantageous, as proven, if at least one action relating to the chord extension and modulation context can be/is assigned to the at least one playing unit or the at least one playing element.

In practical terms, it is advantageous if the musical instrument has at least one amplifier unit and/or at least one loudspeaker, in order to then frequently dispense with physical vocal bodies and acoustically reproduce the generated tones via the at least one loudspeaker.

The invention further claims:

A method for retuning a musical instrument, characterized in that a musical instrument according to the invention is used.

A computer program, in particular when the program is executed on a computer, adapted to carry out the method according to the invention.

A computer program product adapted to carry out the method according to the invention.

A data carrier, comprising a computer program, adapted to carry out the method according to the invention.

A system adapted to carry out the method according to the invention.

A use
of the method according to the invention
and/or
the computer program according to the invention
and/or
of the computer program product according to the invention
and/or
the data carrier according to the invention
and/or
the musical instrument according to the invention
and/or
of the system according to the invention

for playing in such a way that an extension and modulation of any tone space with prime-numbered tone ratios both lower and higher than five can be realized and/or

for playing in such a way that all intervals of a chord and all chords in relation to each other can be reproduced in pure tuning by retuning during playing; and/or

for playing in any key of the circle of fifths defined in relation to the tempered tuning in tempered and pure tuning and in any gradation in between can be realized/is realized in use by means of retuning during playing.

According to the invention, the following is understood under the three terms:

“Tone space”: A tone space represents a finite space of tone locations, which is spanned by fifth (3), third (5), seventh (7) and higher prime vectors, whereby each vector is assigned to its own dimension. All tone locations contained are in a simple integer relationship to the reference tone (1/1) and to each other (Euler's Tonnetz, 1739).

“expandable”: Any tone space can be expanded by vectors with higher prime numbers. The reference tone remains the same.

“modulatable”: Any tone space can be shifted with any prime number vector. Each tone location and thus also the reference tone undergo the same change.

The following explanations represent the general principles of the musical instrument according to the invention.

The instrument according to the invention is set up to manually adjust all tone ratios of any tone space as prime or integer ratios to the current reference tone functionally and dynamically in all details. The adjustment takes place via seven interacting functions (patent claim 6)a) to 6)g)), which enable a maximally differentiated overall intonational result.

The aim is, on the one hand, to improve the intonation of existing musical works, if possible, and, on the other hand, to expand the creative possibilities of harmony and melody by integrating the higher prime-numbered tone ratios in the chord as well as the distance between the reference tones of at least two tonal spaces. The prerequisite for mastering this extended harmony and melody is a deeper understanding of the laws of pure tuning (Prof. Martin Vogel 1923-2007, Die Lehre von den Tonbeziehungen, Bonn-Bad Godesberg 1975).

The aim is not to use automated intonation control to minimize the compromises in terms of the purity of the intervals of any kind of temperament by means of automatic chord recognition and tuning correction. This approach, which is perhaps best described by the term “dynamic tempering”, is already being pursued by various projects and is therefore state of the art: Justonic Pitch Palette, Mutabor, Hermode Tuning, TransFormSynth, and others. Even if this approach can achieve an improvement in intonation in terms of integer tone ratios, it still denies the player active, detailed and therefore comprehensive access to the various intonation parameters. As a result, there is no further artistic freedom. The musician can neither control the process of tuning changes independently nor consciously shape them, as the algorithm working in the background does not recognize the player's artistic intention in the specific harmonic situation. Since there are usually always several fundamentally different interpretations of the harmonic relationships of one and the same piece, the player lacks the possibility of precisely implementing his decisions regarding the exact pitches.

The result is inevitably a standard intonation that remains within certain limits, but only rarely ventures into new musical territory.

This is illustrated by the following example: one of the unwritten laws of music is the endeavor to keep the basic pitch stable. This means that the pitch of the reference note of the original harmony must not change over the course of the piece of music. All the software projects mentioned above strive to fulfill this law. However, if you make music with completely retuned intervals, the phenomenon of intonational “vagabondage”, i.e. the repeated rise and fall of the overall tuning, appears by itself due to the resulting commas.

Various Renaissance masters, such as Heinrich Schütz (1585-1672), used precisely this vagabondage to make the content of the vocal text even more intensely perceptible by means of intonation. In some works, Schütz gave negatively connoted content a falling overall pitch and positively connoted content a rising overall pitch. This was done in an era in which keyboard instruments did not yet dominate in terms of intonation. The melody instruments used (singers, strings, winds) all had a sufficient range that allowed them to depict the compositionally intended, sometimes considerable intonation deviations. At that time, the continuo instrument (chest organ) fulfilled the function of a support instrument for rehearsing the literature rather than that of an exact reference instrument.

The instrument according to the invention provides the player for the first time with a high-resolution reference instrument in terms of intonation, while at the same time offering maximum artistic freedom.

### DETAILED DESCRIPTION OF THE SEVEN PARAMETERS OF PURE TUNING

a. Basic Structure of the Tonal Range (Tonality)

The instrument according to the invention follows harmonic dualism (Arthur von Oettingen 1836-1920, Das duale Harmoniesystem, Leipzig 1913) in the interpretation of the tonal genders: Depending on whether one specifies the lower or the upper tone of an interval or chord as the reference tone, all prime or integer tone ratios can always be interpreted as both upper and lower intervals. If the tone with the lowest frequency is defined as the reference tone, a major chord is created. If the tone with the highest frequency is defined as the reference tone, a minor chord is created. This dualistic approach to major and minor tones offers the decisive advantage that not only the major but also the minor chord can be extended with higher prime-numbered tone ratios. These higher prime-numbered tone ratios, interpreted as lower intervals, always form new pitches that cannot be represented by upper intervals. This opens up new harmonic possibilities for making music in pure tuning.

For this purpose, the instrument offers the possibility of switching between a basic structure of the tonal space in which all pitches are predominantly integer multiples of the reference tone (otonality), i.e. in the range of non-genuine fractions, or predominantly integer divisors of the reference tone (udonality), i.e. in the range of genuine fractions.

b. Limitation of the Tonal Range (Limit)

This parameter concerns the control of the upper or lower limit of the prime-numbered tone ratios or dimensions currently present in the tonal space in Euler's tone network. The term “limit”, which is commonly used today, was coined by Harry Partch (instrument maker, musician, composer, USA, 1901-1974). The aim of this function is to define the number of higher prime-numbered tone ratios for each current harmony centrally and thus effectively.

c. Assignment of the Octave Positions of the Tonal Range (Full Keyboard Tuning)

If you want to make music with higher prime-numbered tone ratios, make sure that they appear in their favorable octave positions in relation to the reference tone according to the overtone or undertone spectrum. The greater the prime-numbered tone ratio, the further away it should sound from the reference tone. Nevertheless, it is possible to freely select the distance to the reference tone within certain limits, i.e. to octave these tone ratios “up” or “down” so that they can still be recognized by the ear in their specific character. To avoid having to select the octave positions manually for each individual tone ratio, the player can use this function to arrange these ratios as groups in the octave spaces above or below the reference tone, depending on the currently set limit. The groups of prime numbers are defined as values within the limits of the upper octaves (2\hat{ }n to 2\hat{ }n+1) for otonality or within the limits of the lower octaves (½\hat{ }n to ½\hat{ }n+1) for unisonality in relation to the reference tone.

d. Shifting of the Tonal Space (Modulation)

The instrument according to the invention offers the possibility of modulating any reference tone together with its defined tonal space via the selection of simple and higher prime-numbered tone ratios. This means that the player not only has access to chord relationships based on fifths (ratios of three) and thirds (ratios of five), but also to higher prime-number relationships (ratios of 7, 11, 13, etc.). These modulations with higher prime number ratios make it possible, for example, to reinterpret a blue note of the blues scale (ratio of 7) as a new reference tone together with its harmonic environment. By integrating the higher prime-number ratios in the chord and using them as the basis for modulating the chord, it is possible to create any number of narrow or wide semitones, which allows you to control the harmonic tension very precisely.

e. Merging Two or More Tonal Spaces (Transition)

This function is a combination of the d. and f. functions and offers advantages if only one keyboard is available. By specifying which pitch locations are still available after the modulation, it is possible to make harmonically distant pitch spaces or pitch locations available simultaneously within certain limits.

f. Distance Between Main Pitch Range and Secondary Pitch Ranges (Distance)

To reduce the number of retunings during playing, it is advisable to work with at least 2 keyboards, each of which is assigned its own tonal space. This function can be used to clearly define the distance between the main reference tone and tone space and the secondary reference tone and tone space or the secondary reference tones and tone spaces by selecting prime or integer tone ratios. This function is indispensable for the full integration of the higher prime-numbered tone ratios into the harmonic movement.

g. Continuous Change Between a Tempered or One-Dimensional and a Multi-Dimensional Tone Space (Progression)

This function offers the possibility of using a continuous controller to switch continuously between a tone space with any temperament or a tone space based on tone ratios of three (limit 3) to a tone space based on tone ratios greater than three (limit >3). All tone locations calculated from this are not whole numbers. Exceptions are the tone locations when the end position of the controller is reached with Limit >3 or Limit 3.

### Progression Melody Tuning Harmony Tuning

1. tempered Limit>3

2. limit 3 limit>3

In order for the listener to grasp a harmonic sequence, a certain amount of time is required for the ear to pick up the frequencies involved and for the brain to analyze them and relate them to each other. If the harmonic change exceeds a certain tempo, the listener is no longer able to clearly correlate different frequencies. The more integer the tone ratios involved, the shorter the time required.

Above a certain tempo of harmonic progression, it no longer makes sense to tune all pitch ratios correctly, as the sometimes extensive pitch corrections necessary for pure tuning are no longer perceived as such by the listener. In this situation, the player is free to glide smoothly either into a pure melodic tuning (Pythagorean tuning) or into any kind of temperament.

The continuous progression to a pure melodic tuning or temperament should depend on the tempo of the change of harmony and should be decided on a case-by-case basis. On the one hand, the continuous change enables a seamless connection of melodic, virtuoso sections (limit 3) to harmonically rich sections of a piece of music (limit >3) and, on the other hand, a seamless connection of very fast harmony changes, where the player lacks the time to make adjustments (tempered), to slower passages with complete adjustment of the pitch parameters (limit >3).

The interaction of redundant control elements optimized for fast operation with the 7 sub-parameters of intonation described here creates the possibility of making music fluently with all details in pure tuning and full artistic freedom.

1. Musical instrument, wherein it is set up in such a way that any tone spaces based either on prime-numbered tone ratios also greater than five or on tempered tone ratios in real time with prime-numbered tone ratios also greater than five or with tempered tone ratios can be both expanded and modulated/can be both expanded and modulated in use.

2. Musical instrument according to claim 1, wherein it is an electromechanical musical instrument with a tuning device for dynamic retuning of tuning bodies, so that any tone spaces based either on prime-number tone ratios also greater than five or on tempered tone ratios in real time with prime-number tone ratios also greater than five or with tempered tone ratios can be both expanded and modulated/can be both expanded and modulated in use.

3. Musical instrument according to claim 1, wherein it is an electronic musical instrument, with a tuning device for tuning virtual tuning bodies, so that any tone spaces based either on prime-number tone ratios also greater than five or on tempered tone ratios in real time with prime-number tone ratios also greater than five or with tempered tone ratios can be both expanded and modulated/in use both expanded and modulated.

4. Musical instrument according to claim 1, wherein it has at least one control element via which at least one action related to tone space expansion and modulation context is activated and/or deactivated.

5. Musical instrument according to claim 4, wherein the at least one action relating to the expansion and modulation context is generated by means of at least one computing unit.

6. Musical instrument according to claim 4, wherein the at least one action related to tonal space expansion and modulation context is one of the following group:
(a) basic structure of the tone space:
Switching between a tone space in which the tone frequencies in relation to the reference tone are calculated predominantly as integer multiples on the one hand and predominantly as integer divisors on the other;
b) Limitation of the tone space:
Selection of an upper or lower limit of the prime-numbered tone ratios present in the tonal space;
c) Assignment of the octave positions of the tonal range:
Switching between an octave-bound and a non-octave-bound replacement of the prime-numbered tone ratios defined by selecting an upper or lower limit with larger or smaller prime-numbered tone ratios corresponding to the octave position;
d) displacement of the tonal space or tonal spaces:
Modulation of a reference tone and its defined tone space or several reference tones and their defined tone spaces that are in prime or whole-number tone ratios via the selection of a prime or whole-number tone ratio;
e) Interlacing two or more tone spaces:
Selection of tone locations that continue to exist after modulation;
f) Distance between main tone space and secondary tone spaces: Selection of the distance between at least two reference tones of at least two tone spaces via the selection of a primary or integer tone ratio or correspondingly several primary or integer tone ratios;
g) Continuous change between a tempered or one-dimensional and a multi-dimensional tonal space:
Switching between a selection of a tuning from a continuous change between any temperament and a tuning based on tone ratios of three (Pythagorean tuning) to a tuning based on tone ratios greater than three.

7. Musical instrument according to claim 4, wherein it has at least one playing unit.

8. Musical instrument according to claim 7, wherein the playing unit has at least one playing element from the group keyboard, pedal.

9. Musical instrument according to claim 7, wherein the at least one playing unit or the at least one playing element can be/is assigned at least one action relating to the tone space expansion and modulation context.

10. Musical instrument according to claim 3, wherein it has at least one amplifier unit and/or at least one loudspeaker.

11. Method for retuning a musical instrument, wherein a musical instrument according to claim 1 is used.

12. A computer program, in particular when the program is executed on a computer, adapted to perform the method according to claim 11.

13. Computer program product, adapted to perform the method according to claim 11.

14. A data carrier containing a computer program, adapted to carry out the method according to claim 11.

15. System adapted to carry out the method according to claim 11.

16. Use of at least one
of the method according to claim 11
and
the computer program according to claim 12
and
the computer program product according to claim 13
and
the data carrier according to claim 14
and
the musical instrument according to claim 1
and
the system according to claim 15
for playing in such a way that an extension and modulation of any tone space with prime-numbered tone ratios also greater than five can be realized/is realized in use; and/or for playing in such a way that all intervals of a chord and all chords in relation to one another can be reproduced in pure tuning/are reproduced in use by means of retuning during playing; and
for playing in any key of the circle of fifths defined in relation to the tempered tuning in tempered and pure tuning and in any linear gradation in between can be realized by retuning during playing/is realized in use.
